(19) United States
(12) Patent Application Publication
(10) Pub. No.: US 2025/0326142 A1
(43) Pub. Date: Oct. 23, 2025

(54) HOLDER FOR ELECTRIC SHAVER

(71) Applicant: Skull Shaver LLC, Sioux Falls, SD (US)

(72) Inventor: Neel Kulshreshtha, Sioux Falls, SD (US)

(73) Assignee: Skull Shaver LLC, Sioux Falls, SD (US)

(21) Appl. No.: 18/640,058

(22) Filed: Apr. 19, 2024

(51) Int. Cl. B26B 19/38

(52) U.S. Cl. CPC B26B 19/3853

(57) ABSTRACT

An example holder for an electric shaver is provided. The holder includes a grip section, and a head section configured to receive the electric shaver. The head section includes a stationary base and an adjustable base movably coupled to the stationary base to allow for insertion of the electric shaver into a space defined by walls of the stationary and adjustable bases.

### BACKGROUND

The present invention is directed toward a holder for electric shavers and, more particularly, toward a holder configured to secure an electric shaver for shaving difficult to reach areas.

Electric shavers generally include a hand-held housing that contains motor and power supply-related components that drive one or more cutters or cutting heads. The housing also provides a form that fits the user's hand sufficiently as a grip so as to allow the user to manipulate the shaver, especially when reaching upward to shave the head. Various types of cutters are well known in the art. In general, the cutter comprises an outer, stationary, apertured surface and an inner array of reciprocating or rotating blades that operate in a shearing engagement with the outer apertured surface. The motor is mechanically coupled to the cutter and provides motion to the array of blades. Hairs that extend through the apertures in the outer surface are sheared by the inner array of blades. Such electric shavers can be used to shave different areas of the body, including a user's back. However, in such instances, either a complex array of mirrors and/or a second individual is typically needed to shave difficult to reach areas.

### SUMMARY

The present disclosure relates to features that are particular to the shaving of the head, face, and/or back, though not in a limiting manner. As understood by one skilled in the art, the principles of an electric shaver are not restricted to the shaving of a specific part of the body, and may apply to any skin surface. Electric shavers designed more particularly for shaving the face have a grip portion that is configured, predominantly, to be held in such a manner so as to orient the grip below the cutting surface. Shaving the head, however, requires the shaver to be held in such a manner so as to orient the grip above the cutting surface. Note, for example, Published Application No. 2009/0025234 to Carlucci and, particularly, FIGS. 7 and 8 thereof.

An example embodiment relates in general to an electric shaver comprising a housing that provides a container for the motor and power source components and further provides a form, also referred to as a grip, that fits the hand in a comfortable manner when the shaver is oriented with the grip above the cutter surface. In other words, in this orientation the cutter faces downward so as to meet the skin surface of the scalp, and the grip is above the cutter. The cutter surface may comprise flexible members that allow the cutter surface to meet the complex curvilinear surface of the head. The grip portion of the housing comprises a pair of substantially concave surfaces each comprising a central axis that is parallel to the cutter surface and, therefore, tangent to the curved surface being shaved.

When the shaver of the present invention is oriented in the above manner, it is possible to either grip the shaver with two fingers as between the thumb and index finger, or between the index and middle fingers, while resting the remainder of the hand against the skin. This helps the user properly orient and place the cutting surface of the shaver against the skin while being able to feel whether the skin has been sufficiently shaved.

Embodiments of the present disclosure provide an exemplary holder or handle for an electric shaver that allows the user to conveniently reach difficult areas of the body for shaving. The holder includes an adjustable head that engages and clamps around the electric shaver to maintain an accurate position of the shaver. Undesired movement of the electric shaver within the head of the holder is prevented. The holder includes a body with at least one pivoting hinge, allowing adjustment of the angle for improved reach.

In accordance with embodiments of the present disclosure, an exemplary holder for an electric shaver is provided. The holder includes a grip section and a head section configured to receive the electric shaver. The head section includes a stationary base and an adjustable base movably coupled to the stationary base to allow for insertion of the electric shaver into a space defined by walls of the stationary and adjustable bases.

The holder includes a top section connected to the head section. The top section is pivotably coupled to the grip section. The holder can include a locking mechanism at a pivot joint between the top section and the grip section. The locking mechanism allows for selective adjustment and locking of an angle between the top section and the grip section.

The walls of the stationary base can include a top wall connected to a fixation wall, and a side wall connected to the fixation wall. In some embodiments, the top wall, the fixation wall and the side wall can extend substantially perpendicularly from the stationary base and can define a substantially C-shaped configuration. In some embodiments, a height of the fixation wall can be dimensioned greater than a height of the top wall and the side wall, and the height of the side wall can be dimensioned greater than the height of the top wall.

The walls of the adjustable base can include a top wall connected to a fixation wall, and a side wall connected to the fixation wall. The walls of the stationary base and the adjustable base can each include a fixation wall extending on opposing sides of the space. In some embodiments, each fixation wall can include an inwardly directed flange at a top edge of the fixation wall. The inwardly directed flange extends over the space.

Each fixation wall includes a cutout extending therethrough. The holder includes a fixation clip configured to be at least partially inserted into and engaged with the cutout of each fixation wall. The fixation clip includes a fixation platform configured to engage with a surface of the electric shaver to prevent removal of the electric shaver from the space.

In accordance with embodiments of the present disclosure, an exemplary electric shaver system is provided. The system includes an electric shaver and a holder configured to releasably receive and engage the electric shaver. The holder includes a grip section and a head section configured to receive the electric shaver. The head section includes a stationary base and an adjustable base movably coupled to the stationary base to allow for insertion of the electric shaver into a space defined by walls of the stationary and adjustable bases.

The walls of the stationary base and the adjustable base can each include a top wall connected to a fixation wall, and a side wall connected to the fixation wall. In some embodiments, a height of the fixation wall can be dimensioned greater than a height of the top wall and the side wall, and the height of the side wall can be dimensioned greater than the height of the top wall. The walls of the stationary base and the adjustable base can each include a fixation wall extending on opposing sides of the space.

Each fixation wall includes a cutout extending therethrough. The system includes a fixation clip configured to be at least partially inserted into and engaged with the cutout of each fixation wall. The fixation clip includes a fixation platform configured to engage with a surface of the electric shaver to prevent removal of the electric shaver from the space.

In accordance with embodiments of the present disclosure, an exemplary method of shaving is provided. The method includes moving an adjustable base of a head section of a holder relative to a stationary base to increase a width between walls of the adjustable base and the stationary base. The method includes positioning an electric shaver into a space defined by the walls of the stationary base and the adjustable base. The method includes moving the adjustable base towards the stationary base to secure the electric shaver in the space between the walls of the stationary base and the adjustable base.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the holder for electric shaver, reference is made to the accompanying figures, wherein:

FIG. 1 is a perspective view of an exemplary electric head razor in accordance with embodiments of the present disclosure.

FIG. 2 is a bottom perspective view of an exemplary electric head razor of FIG. 1.

FIG. 3 is a side view of an exemplary electric head razor of FIG. 1.

FIG. 4 is a perspective view of a first way of holding an exemplary electric head razor of FIG. 1 to shave one's head.

FIG. 5 is a perspective view of a second way of holding an exemplary electric head razor of FIG. 1 to shave one's head.

FIG. 6 is a perspective view of a third way of holding an exemplary electric head razor of FIG. 1 to shave one's head.

FIG. 7 is a perspective view of an exemplary holder for an electric shaver in accordance with embodiments of the present disclosure.

FIG. 8 is a perspective view of a head of an exemplary holder for an electric shaver of FIG. 7.

FIG. 9 is a top view of a head of an exemplary holder for an electric shaver of FIG. 7.

FIG. 10 is a rear view of a head of an exemplary holder for an electric shaver of FIG. 7.

FIG. 11 is a side view of a head of an exemplary holder for an electric shaver of FIG. 7.

FIG. 12 is a perspective view of a fixation clip of an exemplary holder for an electric shaver of FIG. 7.

FIG. 13 is a top view of a fixation clip of an exemplary holder for an electric shaver of FIG. 7.

FIG. 14 is a bottom view of a fixation clip of an exemplary holder for an electric shaver of FIG. 7.

FIG. 15 is a front view of an exemplary holder of FIG. 7 partially engaging an electric shaver.

FIG. 16 is a perspective view of an exemplary holder of FIG. 7 engaging an electric shaver with fixation clips.

FIG. 17 is a front view of an exemplary holder of FIG. 7 engaging an electric shaver with fixation clips.

### DETAILED DESCRIPTION

A more complete understanding of the components, processes, and apparatuses disclosed herein can be obtained by reference to the accompanying figures. These figures are intended to demonstrate the present disclosure and are not intended to show relative sizes and dimensions or to limit the scope of the exemplary embodiments.

Although specific terms are used in the following description, these terms are intended to refer only to particular structures in the drawings and are not intended to limit the scope of the present disclosure. It is to be understood that like numeric designations refer to components of like function.

The term “about” when used with a quantity includes the stated value and also has the meaning dictated by the context. For example, it includes at least the degree of error associated with the measurement of the particular quantity. When used in the context of a range, the term “about” should also be considered as disclosing the range defined by the absolute values of the two endpoints. For example, the range “from about 2 to about 4” also discloses the range “from 2 to 4.”

In one embodiment, the present disclosure relates to a shaver (e.g., an electric shaver, an electric head razor, or the like) that comprises a gripping means and a cutting means, configured in such a manner that allows the shaver to be oriented with the grip portion above the cutter portion, thus making it anatomically convenient to hold the shaver against the top and sides of the head, and generally against the skin of the user when shaving one's face.

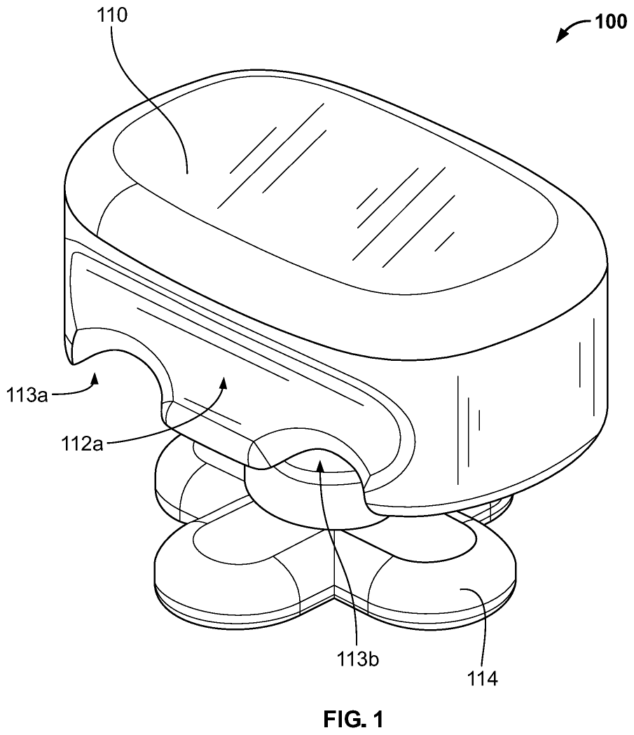

Referring now to the drawings in detail wherein like reference numerals have been used throughout the various figures to designate like elements, there is shown in FIGS. 1-6 an electric head razor constructed in accordance with the principles of the present invention and designated generally as 100.

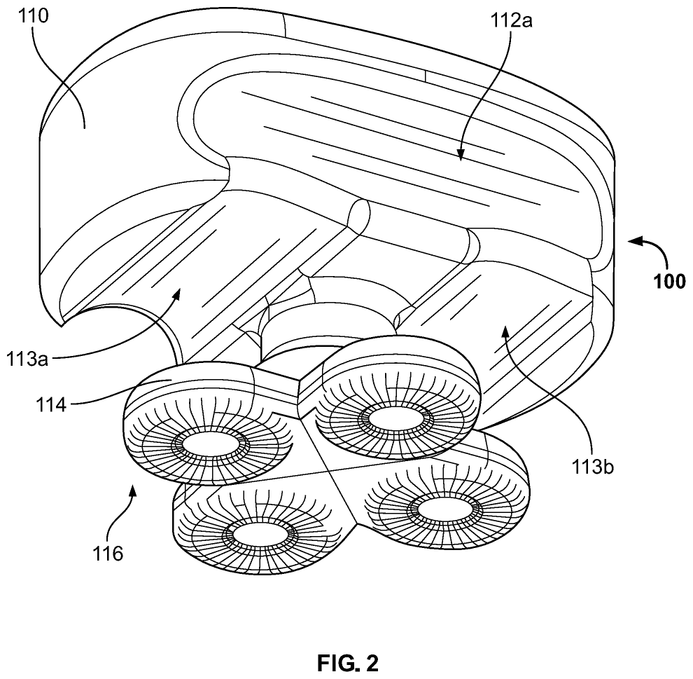

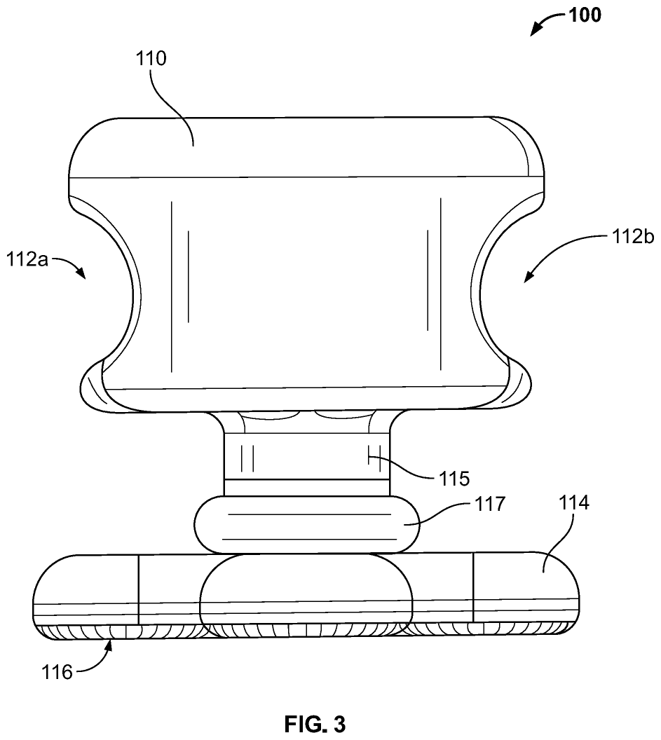

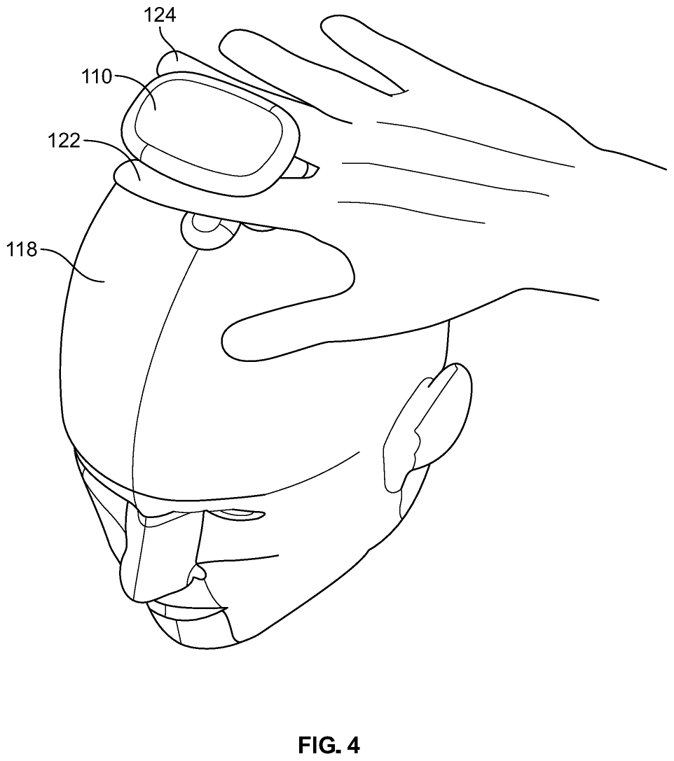

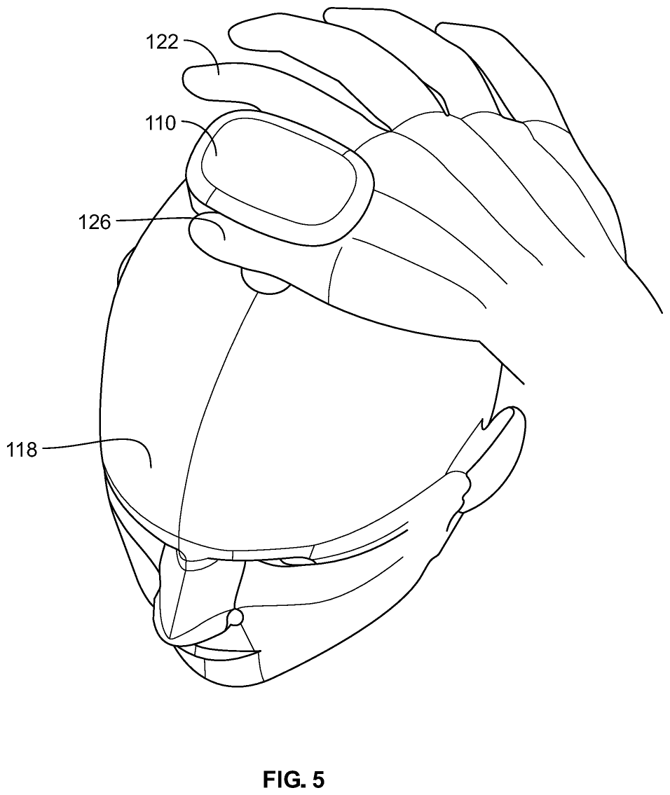

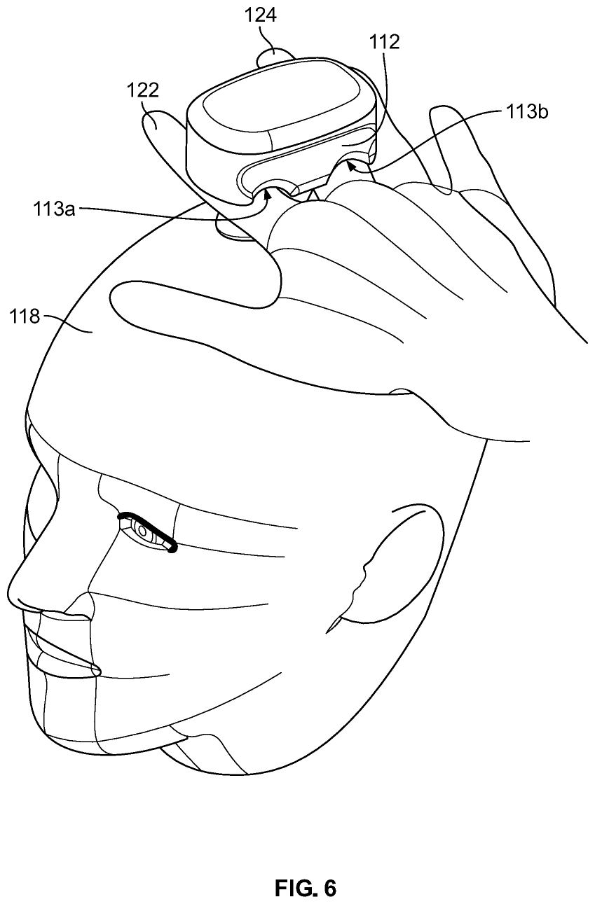

As pointed out above, FIG. 1 is a top perspective view of one exemplary embodiment of an electric shaver of the present invention. FIG. 2 is a bottom perspective view of the shaver of FIG. 1. FIG. 3 is an end view of the shaver of FIG. 1. FIG. 4 is a front, perspective view of the shaver of FIG. 1 depicting the shaver held between the index and middle finger with the cutter surface held against the top of the head. FIG. 5 is a front perspective view of the shaver of FIG. 1 depicting the shaver held between the thumb and index finger and held with the cutter surface against the top of the head. FIG. 6 is a front perspective view of the shaver of FIG. 1 depicting an alternate way of holding the same between the index and middle fingers with the cutter surface against the top of the head.

As shown in FIG. 1 through FIG. 3, the shaver 100 comprises an upper portion 110 that provides a substantially rectangularly shaped housing for a power source and motor related components, and a cutter head 114 that further comprises at least one rotating or oscillating cutter or array of cutters 116. The connection between the motor and the cutter head passes through the central hub 115 which may have an enlarged lower portion 117. The cutter head 114 may be comprised of a flexible or semi-flexible material such as castable elastomer allowing the cutter heads to flex when meeting the curved surface of the head. The motor (not shown) is mechanically coupled to the cutters 116 in a known manner.

The motor, power supply and other related components along with the rotating or oscillating cutters are not, per se, part of the present inventive concept. They are all individually common and well known in the art. Accordingly, detailed descriptions of the same are not believed to be necessary. As is also known, and as can be seen, the rotating or oscillating cutters meet rounded as well as flat surfaces, appropriately for shaving.

The housing 110 further comprises a particular form that provides a gripping means, and fits the hand in a comfortable manner, especially when the shaver is held in an orientation wherein the housing is above the cutter. The gripping means includes a pair of elongated recesses in the form of parallel concave surfaces 112 a and 112 b formed on either side of the housing 110. The concave surfaces are parallel to the plane defined by the cutting surface of the cutters 116. A second pair of elongated recesses in the form of concave surfaces 113 a and 113 b are formed in the under surface of the housing above the cutters 116. The second pair of concave surfaces 113 a and 113 b are arranged to be perpendicular to the first pair of concave surfaces 112 a and 112 b and also parallel to the plane defined by the cutting surface of the cutters 116.

Referring to FIG. 3 and FIG. 4, concave surfaces 112 a and 112 b (FIG. 3) are configured to allow the shaver 100 to be gripped in the manner illustrated in FIG. 4, wherein the shaver is gripped between the index finger 122 and middle finger 124, and held against the scalp 118 with the user's palm facing downwardly. The remainder of the hand may rest against the scalp in a manner that allows the user to feel the surface of the scalp, which helps the user guide the shaver cutting surface as well as inspect the quality of the shave by feel.

Referring to FIG. 3 and FIG. 5, concave surfaces 112 a and 112 b (FIG. 3) are configured to allow the razor 100 to be gripped as illustrated in FIG. 5, in which the shaver is gripped between the thumb 126 and index finger 122, and held against the skull 118. The remainder of the hand may rest against the scalp as in the aforementioned gripping manner.

Referring to FIG. 6, concave surfaces 113 a and 113 b are configured to allow the razor 100 to be gripped as illustrated in FIG. 6, in which the shaver is gripped between the index finger 122 and middle finger 124 with the tops of the fingers lying within the concave surfaces or recesses 113 a and 113 b, and held against the skull 118. In this position, the inside surfaces of the fingers 122 and 124 grip either side of the central hub 115 and the lower part of the fingers press downwardly, at least in part, on the enlarged lower portion 117 of the hub 115. The remainder of the hand may rest against the scalp as in the aforementioned gripping manner.

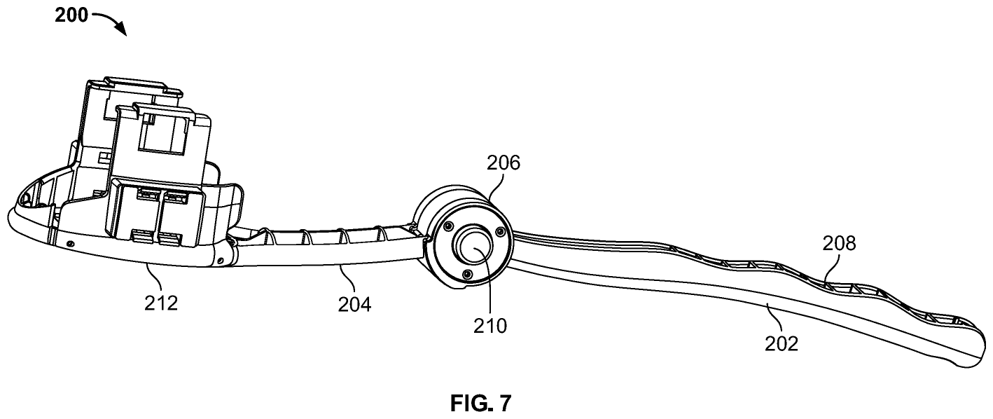

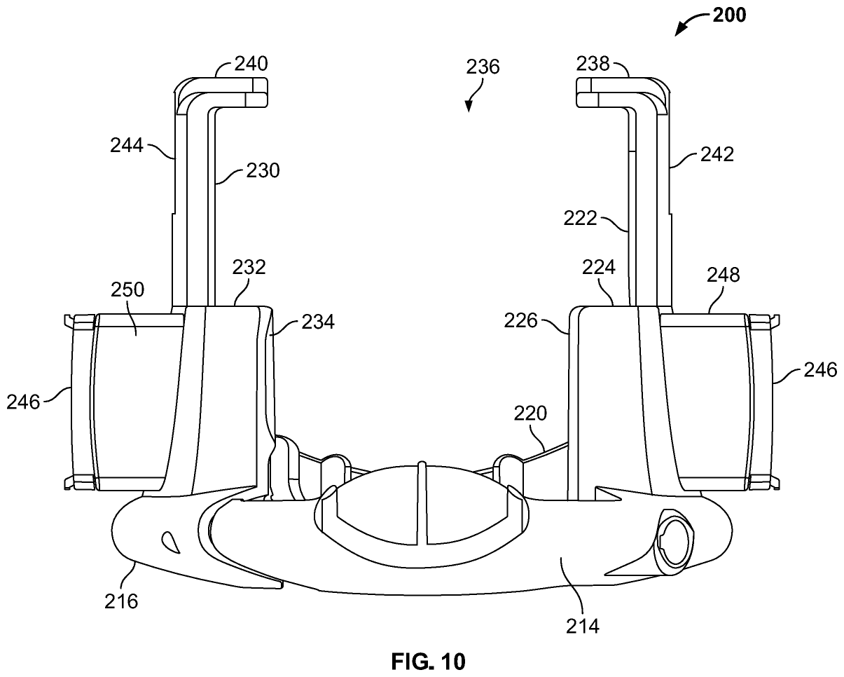

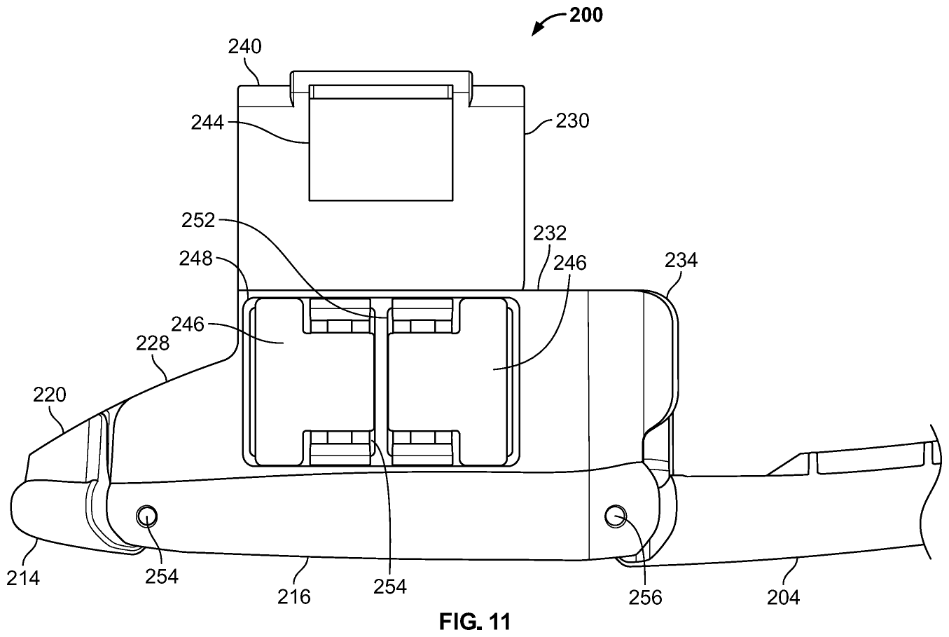

FIGS. 7-17 are perspective, top, rear, side and detailed views of an exemplary holder 200 for use with the electric shaver 100. The holder 200 can be used to releasably engage and clamp around the electric shaver 100 to provide a convenient lever arm for reaching difficult to reach places, e.g., a user's back, or the like. The holder 200 includes a grip section 202 rotatably connected to a top section 204 via a pivot mechanism 206 (e.g., a hinge, or the like). The grip section 202 can define the proximal end of the holder 200 and can include at least one surface 208 with a curving or grooved configuration to provide a more comfortable grip to the user's hand. The grip section 202 can be substantially linear or, in some embodiments, can have a slight curvature.

The pivot mechanism 206 can include a lock 210 (e.g., a locking or engagement mechanism in the form of a spring-loaded button) that allows for selective engagement and disengagement such that the angle between the grip section 202 and the top section 204 can be adjusted and temporarily locked for the needs of the user. The top section 204 can be substantially linear or, in some embodiments, can have a slight curvature. The lock 210 can therefore be used to position the grip section 202 substantially in-line with the top section 204, or at a non-linear angle relative to each other. In some embodiments, the grip section 202 can be rotated to be substantially against the top section 204 for storage or shipping purposes. The distal end of the top section 204 includes a head section 212 configured to releasably engage and couple the electric shaver 100.

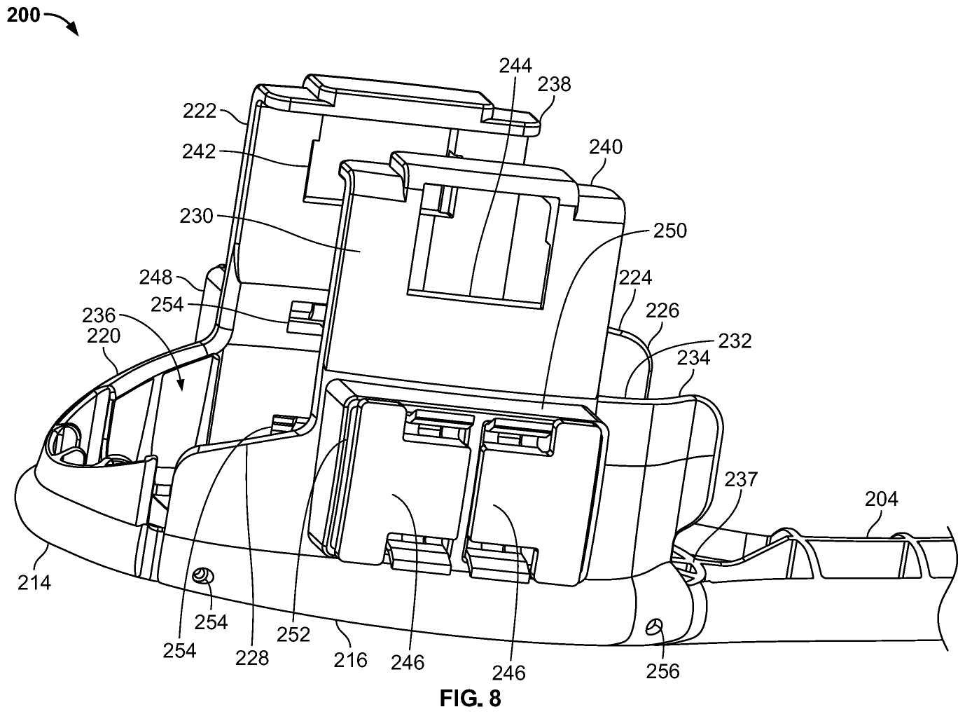

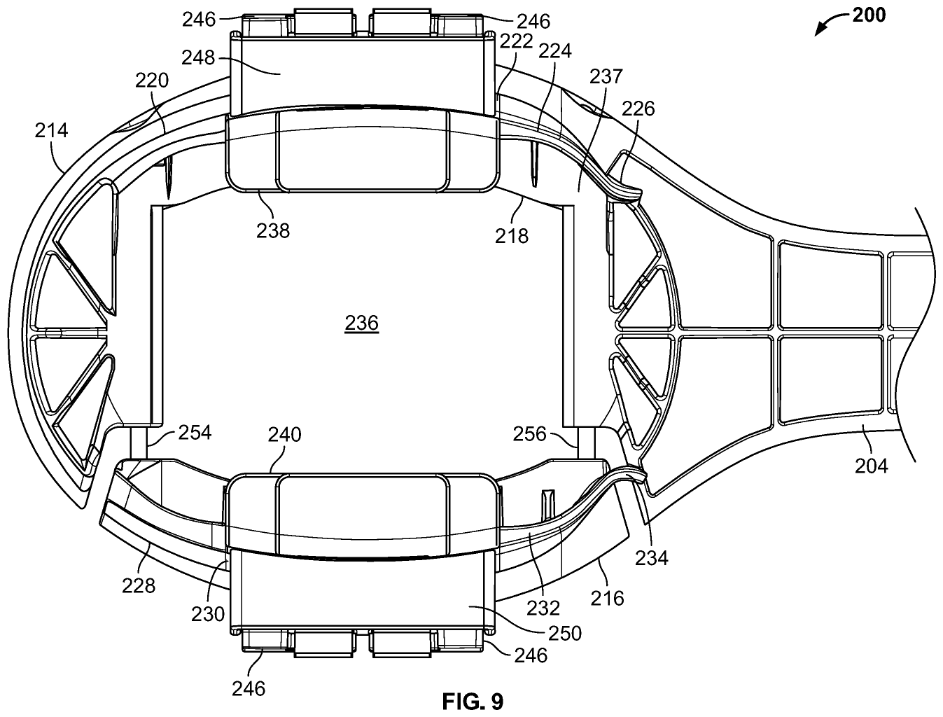

FIGS. 8-11 are detailed views of the head section 212 for the holder 200. The head section 212 includes a stationary base 214 and an adjustable base 216 movably coupled relative to the stationary base 214. The stationary base 214 can define a substantially C-shaped configuration including a central opening 218 defining the bottom of the head section 212. (see, e.g., FIG. 9). The central opening 218 defines a substantially rectangular configuration and provides access to controls of the electric shaver 100 when the shaver 100 is mounted within the head section 212.

The stationary base 214 defines about 75% of the structure associated with the head section 212, and the adjustable base 216 defines about 25% of the structure associated with the head section 212. The stationary base 214 includes a top or distal wall 220 extending perpendicularly from the top edge of the stationary base 214. The distal wall 220 extends along the perimeter of the top edge of the stationary base 214 and connects with a fixation wall 222. The fixation wall 222 extends perpendicularly from the stationary base 214 and is dimensioned greater in height (as measured from the stationary base 214) than the distal wall 220. The fixation wall 222 defines at least a portion of one side wall of the head section 212.

From the opposing edge of the fixation wall 222, the stationary base 214 includes a side wall 224 extending perpendicularly from the stationary base 214 and curving inwardly towards the top section 204. The side wall 224 therefore defines an inwardly curved section 226, as best seen from FIG. 9. The height of the side wall 224 is dimensioned greater in height (as measured from the stationary base 214) than the distal wall 220, but smaller than the height of the fixation wall 222. In combination, the distal wall 220, the fixation wall 222, and the side wall 224 define a substantially C-shaped, curving perimeter wall along a portion of the stationary base 214.

The adjustable base 216 similarly includes a top or distal wall 228 extending along the perimeter of the adjustable base 216 at or near the distal end, and a fixation wall 230 extending perpendicularly from the perimeter of the adjustable base 216. The height of the fixation wall 230 is greater than the height of the distal wall 228. The adjustable base 216 includes a side wall 232 extending from the opposing end of the fixation wall 230, the side wall 232 defining a configuration substantially mirroring the side wall 224 of the stationary base 214. The side wall 232 also includes an inwardly curved section 234 at the end of the side wall 232.

The curved sections 226, 234 are spaced from each other and define a gap or opening at the bottom end of the head section 212. The walls of the stationary base 214 and the adjustable base 216 define a substantially oval configuration, with the gap or opening at the bottom end of the head section 212, thereby defining an enclosure space 236 between the walls for at least partially receiving the electric shaver 100. The inner bottom surface 237 of the stationary and adjustable bases 214, 216 surrounding the opening 218 provide a supporting surface for receiving one end of the shaver 100. The head section 212 includes spring-loaded rods 254, 256 that connect the adjustable base 216 to the stationary base 214. The spring-loaded rods 254, 256 allow the adjustable base 216 to be pulled away from the stationary base 214 to increase the distance between the fixation walls 222, 230, thereby providing clearance for insertion of the shaver 100. Upon release of the adjustable base 216, the adjustable base 216 is biased back into a position substantially adjacent to the stationary base 214 to engage and secure the shaver 100 between the fixation walls 222, 230.

Each fixation wall 222, 230 is substantially centrally positioned along the respective side walls of the stationary and adjustable bases 214, 216. Each fixation wall 222, 230 includes an inwardly directed flange 238, 240 extending from the top edge of the fixation wall 222, 230. The flanges 238, 240 extending substantially perpendicularly from the fixation walls 222, 230 and partially enclose the space 236 at the top of the head section 212. Each fixation wall 222, 230 includes a cutout 242, 244 formed adjacent to the flanges 238, 240. The cutout 242, 244 can be substantially rectangular or square, and is configured complementary to fixation clips 246 provided with the holder 200 (discussed below). The cutouts 242, 244 extend into the space 236 and, in combination with the fixation clips 246, are used to secure the shaver 100 within the space 236.

Below the cutouts 242, 244, each fixation wall 222, 230 includes a storage extension 248, 250 extending outwardly or perpendicularly from the fixation wall 222, 230. The storage extensions 248, 250 include two side-by-side openings 252 with inner cutouts 254 configured to engage with edges of the fixation clips 246 for storage of the fixation clips 246 when the holder 200 is not in use. In some embodiments, fixation clips 246 of different sizes can be provided depending on the type of shaver 100 being used with the holder 200, such that only some of the fixation clips 246 are used with the holder 200 at one time. Thus, the fixation clips 246 can be selectively removed from the storage extensions 248, 250 and engaged with the respective cutouts 242, 244 to secure the shaver 100 within the holder 200.

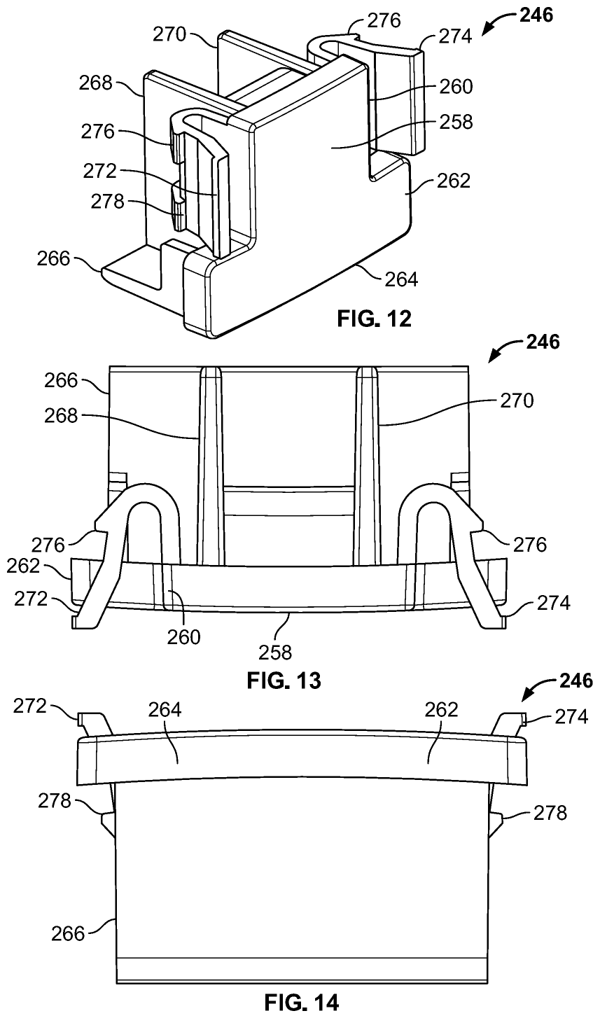

With reference to FIGS. 12-14, perspective, top and bottom views of a fixation clip 246 are provided. The fixation clip 246 includes a front wall 258 that defines a substantially upside-down T-shape with a vertical section 260 and opposing bottom side extensions 262. The extensions 262 define a bottom surface 264 of the fixation clip 246. The front wall 258 can define a substantially planar surface. The bottom surface 264 includes a fixation platform 266 extending out of the rear surface of the fixation clip 246. The fixation platform 266 defines a flat or planar surface configured to be positioned against a surface of the shaver 100 to fully secure the shaver 100 in the holder 200. The opposing side of the front wall 258 includes two spaced support walls 268, 270 perpendicularly extending from both the front wall 258 and the fixation platform 266.

On either side of the vertical section 260, the fixation clip 246 includes flexible latches 272, 274 extending therefrom. Each latch 272, 274 defines a substantially U-shaped configuration with one end attached to the vertical section 260 and the other end free to pivot and flex relative to the vertical section 260. The outer surface of the latch 272, 274 includes hooks or ledges 276, 278 (e.g., two sets of ledges vertically offset from each other). Ends of the latches 272, 274 can be compressed inwardly towards the vertical section 260 with fingers of the user to reduce the overall width of the latches 272, 274, allowing the fixation clip 246 to be partially inserted into the cutouts 242, 244 of the holder 200. Releasing the compressed latches 272, 274 engages the ledges 276, 278 with the inner edge of the cutouts 242, 244 to prevent removal of the fixation clip 246 from the cutouts 242, 244. Two fixation clips 246 can thereby be engaged with opposing cutouts 242, 244 to fully secure the shaver 100 inside of the holder 200.

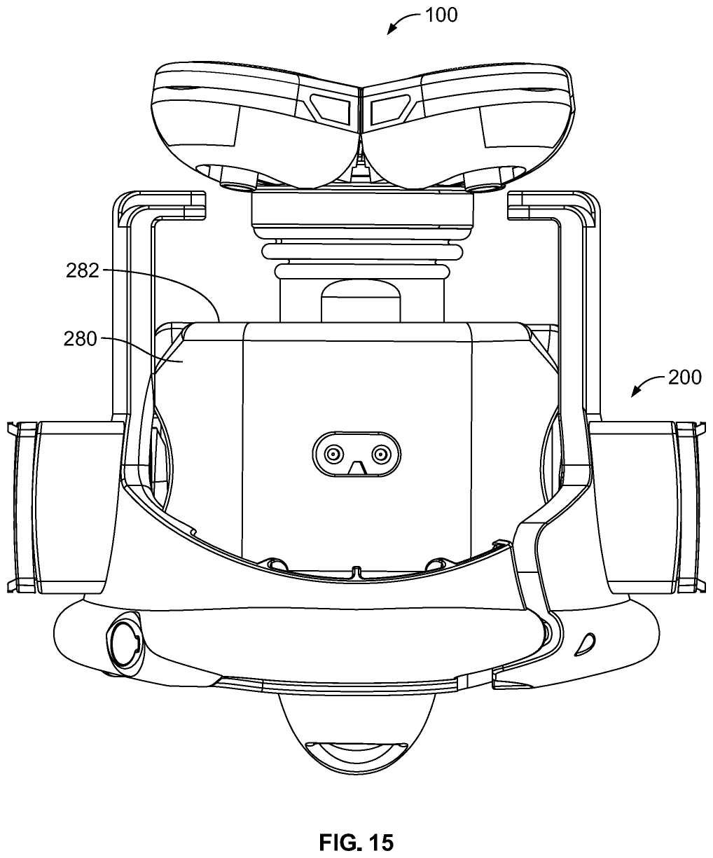

FIGS. 15-17 illustrate insertion and engagement of the shaver 100 into/with the holder 200. The adjustable base 216 is initially pulled out relative to the stationary base 214 to increase the space between the fixation walls 222, 230, allowing for the shaver 100 to be inserted into the space between the fixation walls 222, 230 (see FIG. 15). Although the adjustable base 216 biases against the side walls 280 of the shaver 100, the top surface 282 of the shaver 100 remains free to move up and down within the holder 200.

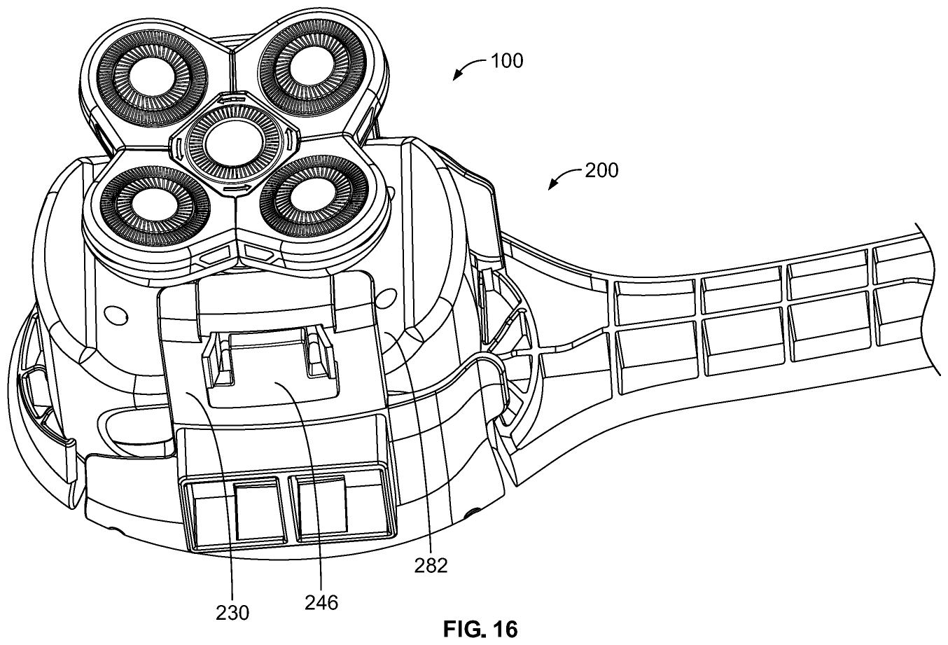

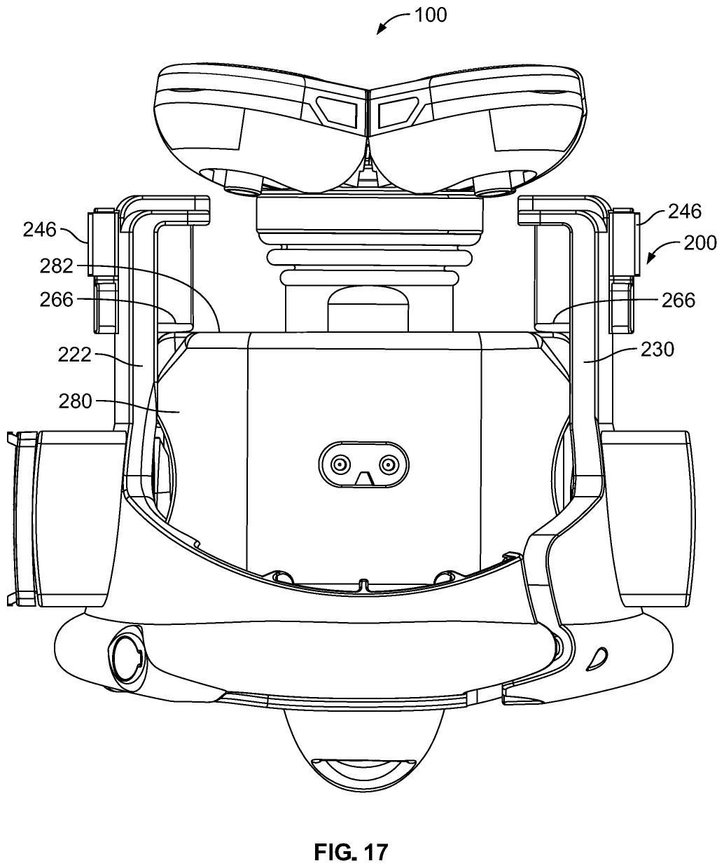

The fixation clips 246 are subsequently inserted into and engaged with the cutouts 242, 244 of the fixation walls 222, 230, locking the fixation clips 246 in position. As shown in FIGS. 16 and 17, when the fixation clips 246 are inserted into the cutouts 242, 244, the fixation platform 266 of the fixation clips 246 rests against and abuts the top surface 282 of the shaver 100. This position of the fixation platform 266 locks the shaver 100 in position within the holder 200, preventing any up and down motion of the shaver 100. The fixation walls 222, 230 and the remaining walls of the holder 200 prevent any other movement of the shaver 100 within the holder 200. After locking the shaver 100 in place with the fixation clips 246, the holder 200 can be used in any orientation for shaving. After use, the fixation clips 246 can be disengaged from the fixation walls 222, 230, and the adjustable base 216 can be flexed away from the stationary base 214 to remove the shaver 100 from the holder 200.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A holder for an electric shaver, the holder comprising:
a grip section; and
a head section configured to receive the electric shaver, the head section including:
a stationary base; and
an adjustable base movably coupled to the stationary base to allow for insertion of the electric shaver into a space defined by walls of the stationary and adjustable bases.

2. The holder of claim 1, comprising a top section connected to the head section, wherein the top section is pivotably coupled to the grip section.

3. The holder of claim 2, comprising a locking mechanism at a pivot joint between the top section and the grip section, wherein the locking mechanism allows for selective adjustment and locking of an angle between the top section and the grip section.

4. The holder of claim 1, wherein the walls of the stationary base include a top wall connected to a fixation wall, and a side wall connected to the fixation wall.

5. The holder of claim 4, wherein the top wall, the fixation wall and the side wall extend perpendicularly from the stationary base and define a substantially C-shaped configuration.

6. The holder of claim 4, wherein a height of the fixation wall is dimensioned greater than a height of the top wall and the side wall, and the height of the side wall is dimensioned greater than the height of the top wall.

7. The holder of claim 1, wherein the walls of the adjustable base include a top wall connected to a fixation wall, and a side wall connected to the fixation wall.

8. The holder of claim 1, wherein the walls of the stationary base and the adjustable base each include a fixation wall extending on opposing sides of the space.

9. The holder of claim 8, wherein each fixation wall includes an inwardly directed flange at a top edge of the fixation wall, the inwardly directed flange extending over the space.

10. The holder of claim 1, wherein each fixation wall includes a cutout extending therethrough.

11. The holder of claim 10, comprising a fixation clip configured to be at least partially inserted into and engaged with the cutout of each fixation wall.

12. The holder of claim 11, wherein the fixation clip includes a fixation platform configured to engage with a surface of the electric shaver to prevent removal of the electric shaver from the space.

13. An electric shaver system, comprising:
an electric shaver; and
a holder configured to releasably receive and engage the electric shaver, wherein the holder comprises a grip section and a head section configured to receive the electric shaver, the head section including:
a stationary base; and
an adjustable base movably coupled to the stationary base to allow for insertion of the electric shaver into a space defined by walls of the stationary and adjustable bases.

14. The electric shaver system of claim 13, wherein the walls of the stationary base and the adjustable base each include a top wall connected to a fixation wall, and a side wall connected to the fixation wall.

15. The electric shaver system of claim 14, wherein a height of the fixation wall is dimensioned greater than a height of the top wall and the side wall, and the height of the side wall is dimensioned greater than the height of the top wall.

16. The electric shaver system of claim 13, wherein the walls of the stationary base and the adjustable base each include a fixation wall extending on opposing sides of the space.

17. The electric shaver system of claim 16, wherein each fixation wall includes a cutout extending therethrough.

18. The electric shaver system of claim 17, comprising a fixation clip configured to be at least partially inserted into and engaged with the cutout of each fixation wall.

19. The electric shaver system of claim 18, wherein the fixation clip includes a fixation platform configured to engage with a surface of the electric shaver to prevent removal of the electric shaver from the space.

20. A method of shaving, comprising:
moving an adjustable base of a head section of a holder relative to a stationary base to increase a width between walls of the adjustable base and the stationary base;
positioning an electric shaver into a space defined by the walls of the stationary base and the adjustable base; and
moving the adjustable base towards the stationary base to secure the electric shaver in the space between the walls of the stationary base and the adjustable base.
